(19) United States
(12) Patent Application Publication
(10) Pub. No.: US 2014/0344465 A1
(43) Pub. Date: Nov. 20, 2014

(54) SUBSCRIBER FOR USE IN A DIGITAL TRANSMISSION SYSTEM, DIGITAL TRANSMISSION SYSTEM AND METHOD FOR DATA TRANSMISSION

(71) Applicant: Lothar Jagusch, Bonn (DE)

(72) Inventor: Lothar Jagusch, Bonn (DE)

(73) Assignee: EATON ELECTRICAL IP GMBH & CO. KG, Schoenefeld (DE)

(21) Appl. No.: 14/358,303

(22) PCT Filed: Nov. 14, 2012
(86) PCT No.: PCT/EP2012/072649

§ 371 Date: May 15, 2014

(30) Foreign Application Priority Data
Nov. 15, 2011 (EP) 11189130.5

(51) Int. Cl. H04L 29/08

(52) U.S. Cl. CPC H04L 67/14; H04L 69/326
USPC 709/228

(57) ABSTRACT

A method for data transfer in a digital data transfer system with at least two participating devices includes connecting the at least two participating devices through a data connection. A protocol stack is processed by a processor of the at least two participating devices. Data exchange between the at least two participating devices via the data connection is organized by means of a communication call routine in a session layer of the protocol stack. The data is assigned to a series of messages by a write-read routine in a transport layer of the protocol stack and configured to at least one of fill and read out a memory buffer. At least two predefined priority levels are defined in the messages for transporting the data with different priority levels.

### CROSS-REFERENCE TO PRIOR APPLICATIONS

This application is a U.S. National Phase Application under 35 U.S.C. §371 of International Application No. PCT/EP2012/072649, filed on Nov. 14, 2012, and claims benefit to European Patent Application No. EP 11189130.5, filed on Nov. 15, 2011. The International Application was published in German on May 23, 2013 as WO 2013072384 A1 under PCT Article 21(2).

### FIELD

The invention relates to a data transfer method in a digital transfer system with at least two participating devices, the at least two participating devices being connected through a data connection, a participating device for application in a digital transfer system with at least one other participating device, particularly a switching device and/or an operating, control or networking device; as well as a digital transfer system with at least two participating devices.

### BACKGROUND

EP1814002A1 shows a data acquisition system for a distributed automation system. In this document, an automation system is proposed in which a field device and a database system are directly interconnected through a network and the datum from the field device can be actively and directly transferred to the database through the network.

DE 10 2005 003 011 A1 shows an example of a digital transfer system with a point-to-point connection. In a digital transfer system, which is assumed here, the participating devices include on the one hand a switching device, such as for example a circuit breaker or a motor circuit breaker, and on the other hand a control device, such as for example a gateway, an operator control unit or a PC with interface and suitable software. The multitude of different switching devices which can be used as participating devices has in common the fact that they capture the current and possibly other physical quantities, and perform switching operations if applicable. However, the concrete data types which are processed by the various switching devices and also by the control devices in the form of physical quantities and/or switching commands differ considerably. To this end, participating devices generally have a processor for processing protocol stacks which are individually adapted to the special circumstances of each participating device. Such individually assembled point-to-point connections for each participating device allow optimal communication, but are admittedly expensive to construct and to modify. In order to attain higher compatibility of participating devices for application in a digital transfer system, and/or to reduce the expense of adapting the participating devices in a digital transfer system, the data transfer can be simplified to the effect that all participating devices are given a unitary communication interface, in other words a common protocol stack, wherein the communication interface is basically adaptable to the data structure of the respective participating device through modular construction of the protocol stack, but individually adapted processing of the specific data does not occur.

### SUMMARY

In an embodiment, the present invention provides a method for data transfer in a digital data transfer system with at least two participating devices. The at least two participating devices are connected through a data connection. A protocol stack is processed by a processor of the at least two participating devices. Data exchange between the at least two participating devices via the data connection is organized using a communication call routine in a session layer of the protocol stack. The data is assigned to a series of messages by a write-read routine in a transport layer of the protocol stack and configured to at least one of fill or read out a memory buffer. At least two predefined priority levels are defined in the messages for transporting the data with different priority levels.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1, a schematic of a possible system structure for application of the method according to an embodiment of the invention;

FIG. 2, a diagram for clarifying the structure of a message;

FIG. 3, a diagram for clarifying a data object;

FIG. 4, a point-to-point protocol stack corresponding to the method according to an embodiment of the invention with reference to an OSI reference model;

FIG. 5, a portion of the structure of FIG. 1 in a detailed schematic view; and

FIGS. 6 through 8, three exemplary cases for communication between two participating devices.

### DETAILED DESCRIPTION

In an embodiment, the invention consists in optimizing communication in a unitary communication interface.

A data transfer method according to the invention in a digital transfer system with at least two participating devices provides that at least two participating devices are connected through a data connection. A protocol stack is processed using the processor of the participating device. The following description of protocol stacks refers to an OSI reference model (Open Systems Interconnection Reference Model), a layered model known to specialists which serves as the basis for communications protocols. Data exchange between the at least two participating devices through the data connection is organized by means of a communication call routine in a session layer of the protocol stack. A write-read routine for filling and/or reading out the memory buffer in a transport layer of the protocol stack assigns the data to a series of messages. Here, according to the invention, at least two different predefined priority levels are defined for data transport.

Defining different priority levels gives the possibility of advantageously transferring certain data with priority over other data. The method is thereby better suited to the circumstances of data transfer because, depending on the participating device, other data are considered important.

One preferred exemplary embodiment of the method provides that each message is subdivided into a plurality of segments, at least one status data segment being for data with the highest priority level and at least one data field segment being defined for data with other priority levels. This means that data with the highest priority level are written into each data message and are consequently updated at each transfer, as the status data segment is reserved for these data in the highest priority level.

Another preferred exemplary embodiment of the method provides that data needing to be cyclically transferred are entered into at least one first data field segment and one second data field segment per message. The data are assigned to the first data field segment and/or to the second data field segment, following the round-robin algorithm in particular. Data to be transferred cyclically form a second priority level below the data to be written into the status data segment. The cyclic data are transferred on a running basis, but not completely with each data message. If there is not sufficient storage space for all cyclic data, these are sent distributed over several messages using the round-robin algorithm.

Another preferred exemplary embodiment of the method provides that a notice segment is assigned to at least one data field segment, information being passed in the notice segment regarding whether a requirement exists for acyclic data and/or whether the associated data field segment contains acyclic data. For the purpose of the invention, a third priority level below the cyclic data is designated for data which are not transferred on a running basis, but only when required. Acyclic data are advantageously written into the data field segments in the same way as cyclic data. The notice segment correspondingly contains the information regarding what type of data, cyclic or acyclic, are present. In the opposite direction, the notice segment advantageously serves simultaneously for delivering the requirement for acyclic data to the participating device.

Also preferably, a data object is transferred with each data field segment, data of a particular type being assembled into a data object. Data objects in particular are defined in a layer of the protocol stack above the communication call routine. This serves to allow adaptation of a unitary protocol stack to the respective participating device, that the type of data which it supplies are selected here from the aggregate of defined data objects. Preferably, identical protocol stacks are processed by the processor of the at least two participating devices, with the exception of a configuration of the data set of the objects applied in the device, which is carried out in a configuration step according to the properties of the respective participating device.

Another object of the invention is a participating device for application in a digital transfer system with at least one other participating device, which preferably operates using the previously described method. According to the invention, a communication module is provided for connecting the participating device with the at least one other participating device through a data connection, as well as memory buffers for data storage and a processor for processing a protocol stack, a communication call routine forming a session layer of the protocol stack for organized exchange of data between the participating device and the at least one other participating device through the data connection, and a write-read routine for filling and/or reading out the memory buffer is provided in a transport layer of the protocol stack, the write-read routine assigning the data to a series of messages and each message having at least two priority levels for data of different priority levels.

The different priority levels advantageously offer the possibility that the participating device can transfer certain data with priority over other data. Thus the circumstances of the respective participating device can be better taken into account in transferring data, as other data are considered important depending on the participating device.

According to one preferred embodiment, it is provided that each message is subdivided into a plurality of segments, at least one status data segment being provided for data with the highest priority level and at least one data field segment being provided for data with other priority levels. Each data field segment is preferably provided for transferring one data object, data of one particular type being assembled into a data object. One layer of the protocol stack preferably forms a definition of the data objects above the communication call routine.

According to another preferred embodiment, it is provided that at least one first data field segment and one second data field segment per message are provided for transferring data to be transmitted cyclically. Assignment of the data to the first data field segment and/or to the second data field segment is preferably accomplished using a round-robin algorithm.

According to another preferred embodiment it is provided that a notice segment is assigned to at least one data field segment, the notice segment being provided for transmitting information regarding whether a requirement exists for acyclic data and/or whether the assigned data field segment contains acyclic data.

In a digital transfer system with at least two participating devices, which is also an embodiment of the invention, the processor of the at least two participating devices process identical protocol stacks, with the exception of a configuration which can be carried out according to the properties of the participating device. The configuration includes in particular a definition of data object which are sent by the participating device.

The invention will be described in further detail below based on one embodiment, with reference to the drawings. The embodiments pertain to the method according to the invention and to the participating device according to the invention for application in a digital transfer system with at least one other participating device and the digital transfer system with at least two participating devices.

According to various possible embodiments of the invention, a distinction is made between status data, cyclic and acyclic data, both in the method according to the invention and in the device according to the invention. According to one preferred embodiment, status data consist for example of individual bits which describe states of the device, e.g. ON/OFF/TRIP, communication in progress, status of power supply voltage. According to one preferred embodiment, cyclic and acyclic data are grouped in the form of objects. Here, an object according to one embodiment is an assemblage of data of the same type, for example data regarding currents, voltages, device identification, parameters.

According to one preferred embodiment, cyclic data are “automatically” and repetitively transferred, i.e. the corresponding object is transferred over and over again without requiring user intervention or any other explicit request for these data. In contrast, according to one preferred embodiment, acyclic data are transferred only one time and upon request.

The method according to an embodiment of the invention and the device according to an embodiment of the invention, particularly the participating device of the invention, can include one or more of the following features:

1. A communication method wherein at least two priority levels are provided in the message
2. The priority levels are achieved by segmentation of the message, there being for example at least one segment with high priority status data and a data field segment for other data.
3. The data field contains data objects which aggregate data of a single type (currents, voltage, etc.)
4. Data objects are cyclically transferred into the data fields; more than one data field can be present.
5. Data fields can have notice segments assigned to them containing information regarding whether acyclic data are required and/or transferred.
6. The definition of the data objects occurs in a layer above the actual communication routine (OSI/ISO reference model)
7. all participating devices use the same software for controlling communication; the data objects employed can however be different

The exemplary embodiment of the method according to the invention and of the digital transfer system according to the invention described here with reference to FIGS. 1 through 8 is a communication system which can be used for various switching devices. The system is so designed that it makes possible optimal transfer of the available data for these devices. At the same time, it is easily adapted to the requirements of the individual devices.

The method takes as its basis the system structure schematically illustrated in FIG. 1. At the left side of the illustration is an indefinite number of switching devices 11, 12, 13 through 1N, where 1N designates the N-th switching device. The various switching devices, such as for example circuit breakers or motor circuit breakers, have the common feature that they acquired the current and possibly other physical quantities, and carry out switching operations if applicable. Each of them can be coupled either directly through a first connection 10 or through an interposed display or control unit 21, 23 through 2N and a second connection 20 with a field bus gateway 31, 32, 33 through 3N, which the bus connection 40 generates with a field bus master. Moreover, the connection of each to a PC 41, 42 through 4N is possible with suitable software, for example through a branched connection 30, either to the device 12 itself or to the display 21, 2N. Depending on the embodiment, this connection 30 could be accomplished in addition to or instead of the connection to the gateway 31, 32, 3N.

Devices which can be connected into such a system are for example switching devices, namely open or compact circuit breakers, motor starters, motor circuit breakers, motor protection systems, soft starters and frequency converters, as well as operator control modules, controllers and networking devices such as display and operator control units, field bus gateways PCs with suitable software, and other devices can be added to the list.

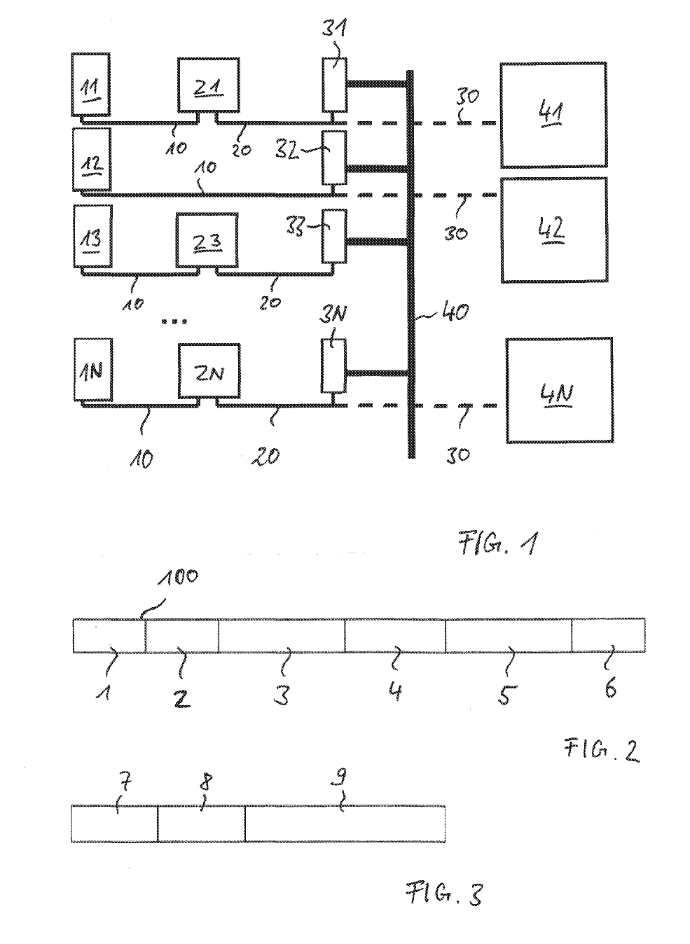

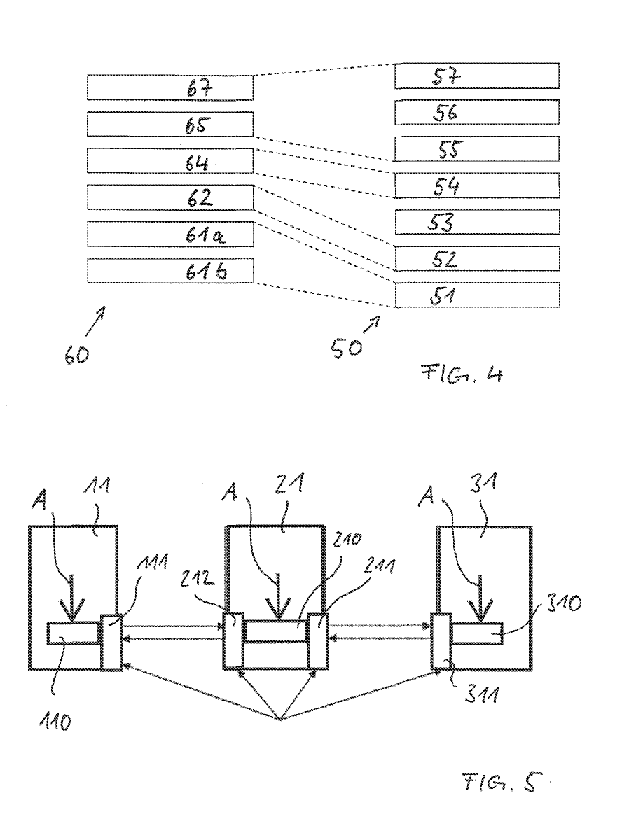

The data message 100 will now be discussed with reference to FIG. 2. The devices that are connected using the method according to the invention generally have different kinds of data. In order to be suitable for them and to achieve the most effective possible transfer, the data message 100 is subdivided for information transfer into a plurality of segments 1 through 6. An identification segment 1 contains an unchangeable message identifier, serial numbering for example. A status data segment 2 contains an overview of the state of the device and/or of the connected loads. Here for example alarm conditions will be shown, without however indicating concrete values. The status data are typically the quickest to be updated, for example roughly every 15 to 25 milliseconds, and are generally used in higher-level systems, such as a programmable logic controller (PLC) or a process control system, for flow control.

A first data field 3 and a second data field 5 are provided for accommodating data which are cyclically transferred, such as for example sensor values, time information and the like. These data are lower in significance than the status data and are accordingly updated less often, typically about every 50 to 200 milliseconds. Each of the two data fields 3, 5 transfers a data object (see FIG. 3), in which data of the same type are aggregated. For example, all effective currents or phase voltages can be bundled into one object each. Devices which cyclically transfer more than two data objects, alternate the content of data fields 3, 5 in each transfer cycle. In a device with five objects A, B, C, D, E, for example, that means that in the first cycle objects A and B, in the second cycle objects C and D, and in the third cycle objects C and A again are transferred, which is also called a round-robin procedure.

A notice segment 4 offers the possibility of a targeted query of device data. This is particularly important for data which are not to be cyclically transferred, as e.g. identification data of the device or the content of an event memory. These data are not constantly needed, but rather are explicitly requested when required. The request (REQuest) or the response (RESponse) thereto are flagged in the notice data segment 4, also called the REQ/RES field. This field 4, however, contains no data whatsoever, but rather only the indication that a request or a response is available. Data field 5 is used for the actual data, when required.

A checksum segment 6 contains for example a CRC-16 checksum for the message contents and thus serves to secure the transmitted data. This message structure ensures that all data are transferred according to their relevance. Status data, as the most important information, come as quickly as the device itself can supply them. The cyclic data are transported at the same pace, but here longer update times come into play due to the round-robin algorithm. As a third level, moreover, specific data can be requested and transferred on a targeted basis.

All data from data fields 3, 5 are assembled into data objects as shown in FIG. 3. These objects each consist of an object header 7, 8 which indicates the type of data, and of the actual data 9. The object header includes a field 7 for a classification of the data and a field 8 for an enumeration for distinguishing data of the same class. In the data field 9, 24 bytes for example are available for data. Object definitions are determined uniformly for the entire system. This means practically that, a data file with the object definitions, once established, is used with all devices in the system. Which objects from this pool are actually used can in any case differ from device to device. In any case, by using an object, the corresponding variables are automatically compiled. All unused variables are also not taken into account in compilation, and thus occupy no resources in the micro-controller. This method offers the advantage that the highest possible compatibility between devices is attained. As all devices are attached to the same database, false interpretations are almost completely excluded. Should an object not be supported by a participating device, then in the worst case it is not evaluated or passed on. As the formal requirements of the transfer protocol are satisfied despite this, this will have no further effects such as for example destruction of the message, loss of data or a system crash.

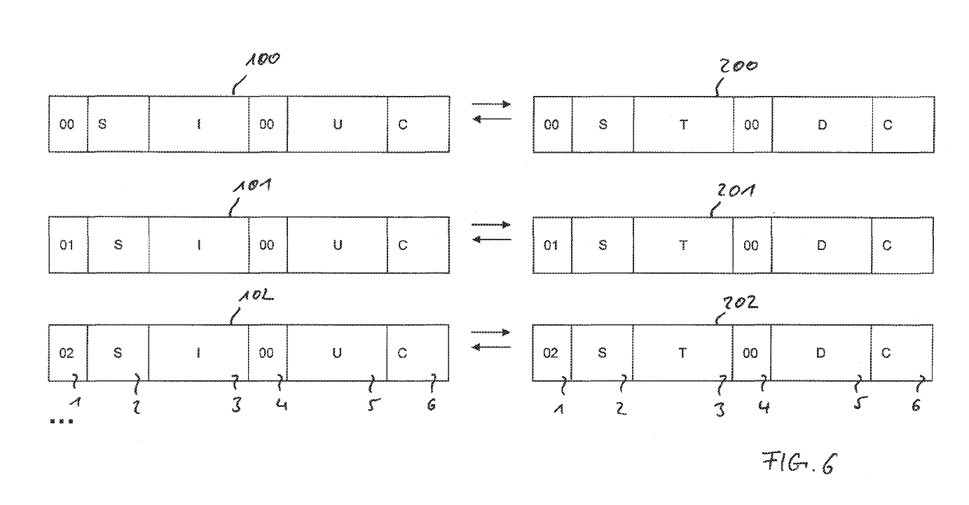

With reference to FIG. 4, a point-to-point protocol stack 60 is described hereafter according to the method of the invention, with reference to an OSI reference model with seven layers. The OSI reference model 50 essentially assumes a network with more than two participating devices, while the method according to the invention provides for point-to-point communication. Accordingly, the layer structure is not exactly congruent. Application layer 57, presentation layer 56 and session layer 55 were combined for defining the data objects 67 and the actual communication call 65 within the device software. Here, the data interface for the actual application and the fundamental communications aspects such as assembly and disassembly or monitoring are essentially implemented. Here, however, no actual presentation layer exists in the protocol stack 60, as the interface to the application is identical for all participating devices and consequently no conditioning of the data needs to occur.

The transport layer 54 in the OSI reference model 50 corresponds directly to the routines for filling and reading out the transfer buffer 64. Here it is specified which data objects must be transferred next, whether for example an acyclic data request (Request) needs to be responded to.

A network layer 53 is dispensed with in the protocol stack 60, as no network is present, but rather a point-to-point connection. A network layer 52 is in turn directly covered by the transmission and reception routines 62. Here the securing of the data transferred and to be transferred and their correct onward routing to the corresponding bit transfer layer 51 is implemented. The bit transfer layer 51 consists, in the method according to the invention, of two layers, a hardware abstraction layer (HAL) 61a, which deals with the adaptation to the processor employed, and the actual physical interface 61b.

The kernel region, consisting of the call to the communication routines 65 and the filling and emptying of the memory buffer 64, always remains unchanged, while all other layers can be adapted to the respective needs. The scope of the data object layer 67 is determined by the use of the predefined data objects, which vary according to the device. The type of communication algorithm is defined by the transmission and reception routines 62. These thus determine whether for example an asynchronous data exchange by UART is used or synchronous algorithm such as SPI. Switching between algorithms is thus accomplished by replacing the corresponding routines. All other components of the system remain the same. Adaptation to the hardware actually in use is carried out by means of the hardware abstraction layer 61a, meaning on the micro-controller. This makes possible the use of all overlaid layers with different micro-controllers.

Due to the modular construction and the broad adaptability, it is possible to make the software universal. This means that it is only programmed once, and need then be only slightly configured for use in the respective device.

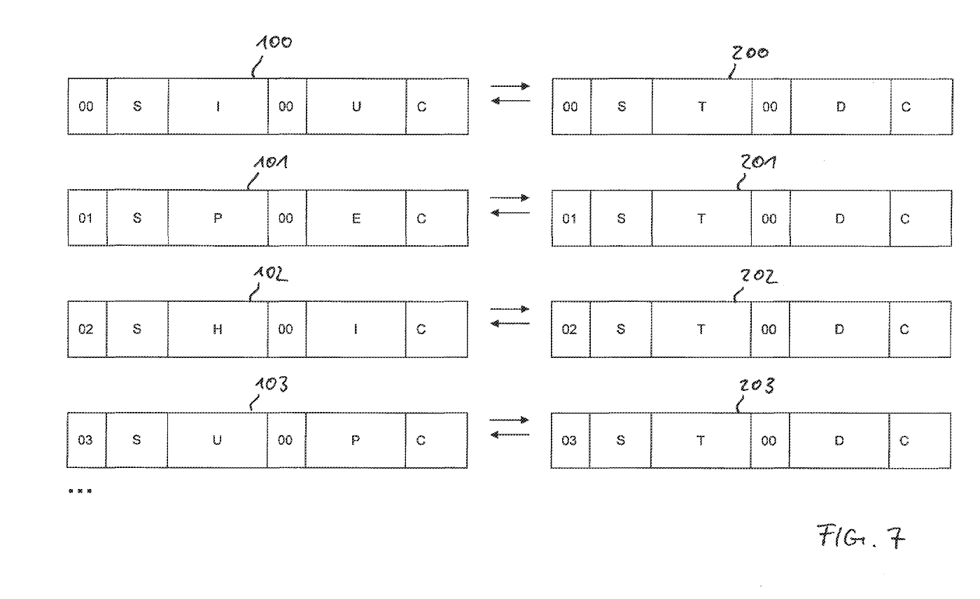

One example is shown in FIG. 5. The same software is used for communication both in the circuit breaker 11 and in the display 21 and the gateway 31. It differs only in its configuration, which can be adjusted to the needs of the individual devices in a few steps. The circuit breaker 11 has only one interface 111 and one internal memory 110. The arrows A show that internal processes of the respective devices have an effect on the stored contents. The circuit breaker 11 supplies sensor values and receives parameter data. The display 21 has two interfaces 211, 212 and a memory 210. It receives sensor values from the circuit breaker 11, displays them and routes them onward to the gateway 31, receives parameters from the gateway 31, displays them and routes them onward to the circuit breaker 31. The display 21, for its part, can request by menu control data such as parameters or identification of the circuit breaker 11 and gateway 31. The gateway 31 has only an interface 311 and a memory 310. It receives sensor values which are passed on by the circuit breaker 11 through the display 21 and transmits parameters, which are passed on by the display 21 to the circuit breaker 11. All these configurations can be implemented without programming effort; only selection of the required properties in the configuration files is required for each device.

Advantages of the method according to the invention and of the digital transfer system according to the invention are rapid updating of important data, achieved by a suitable message structure, and at the same time maximum flexibility, achieved by structuring of the data into objects. Nearly arbitrary scalability is thereby made possible. Improved compatibility is achieved due to the object structure; unknown objects can simply be ignored, but do not lead to system errors. System costs can be kept comparatively low, as the firmware can be used for various device classes. Moreover, the system does not demand specific hardware, such as for example bus controllers, so that no costs arise here. In the simplest case, two micro-controllers can be directly coupled together. Due to the HAL 61a, implementation is possible on any hardware platforms desired. Simple application is achieved due to the provision of a project template for implementation in switching devices. Development is accelerated by a generally applicable communication system which remains only to be configured. Accelerated testing is accomplished through configuration of communication instead of programming. Known methods and components are available for this purpose and testing is accelerated. In addition, the probability of error is drastically reduced, because the system is no longer programmed, but rather the existing firmware only remains to be configured. Good maintainability is achieved due to the modular system (layers).

On the basis of the message structure described in connection with FIG. 2, three data transfer cases according to FIGS. 6 through 8 will be described hereafter. Here a switching device, a circuit breaker for example, will always be assumed, which communicates with an external device, a display for example. Here the external device will usually send relatively few data. For the examples it is assumed, with the exception of a data request in the third case, that it only conveys time and datum information T, D in data segments 3, 5 to the switch. The switching device transmits the messages designated 100, 101, 102 etc., each increment constituting a new cycle. The messages sent from the external device are correspondingly designated 200, 201, 202, etc. Data segments 1 through 7 are only shown by way of example on a few messages.

In the example of FIG. 6, the circuit breakers sends only two objects, namely current I and voltage U, represented by the corresponding designation of data fields 3, 5. As all data are transferred in one cycle, all messages 100, 101, 102 appear identical, with the exception of the serial message number in the identification segment 1 and the checksum in checksum segment 6, which is labelled C here. The transferred values for the current I and the voltage U can naturally also change from cycle to cycle. The status data are designated S and are transferred in each cycle in the status data segment 2. In the notice data segment 4, a null value 00 is transmitted, which means that no acyclic data were requested or transferred.

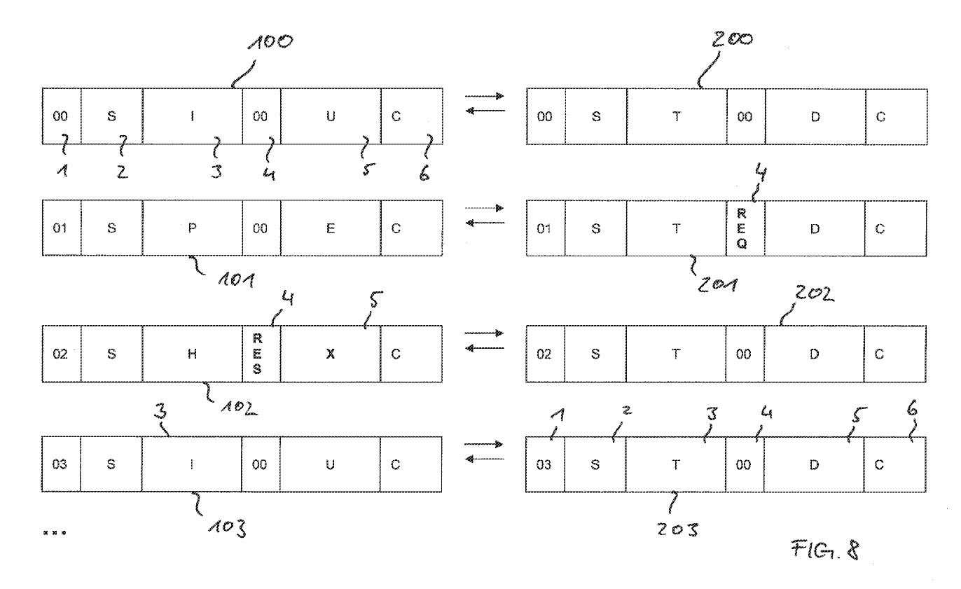

In FIG. 7, a case example is shown according to FIG. 6, but with a higher data traffic. The circuit breaker sends five objects, namely current I, voltage U, power P, energy E and temperature H. Thus not all data can be transferred in one cycle. These are distributed among the data segments 3, 5 of several telegrams 100, 101, 102 and are then repeated starting with the object in the second data segment 5 in message 102, that is in the third cycle. In the notice data segment 4, a null value 00 is transmitted, which means that no acyclic data were requested or transferred.

A case example corresponding to FIG. 7 is shown in FIG. 8, that is with increased data traffic, an acyclic data request being additionally made to the circuit breaker. For this purpose, the external device transmits in the second message, 201, in the notice segment 4, the data request REQ, for example using type code X of the switching device, which it answers in the third cycle with the message 102, in which, instead of the actually occurring current value I, type code X is written in the second data field 5 and an answer designator RES is placed in the notice segment 4. The transmission of the currents I is thus deferred to the first data object in the first data segment 3 in the fourth message 103 in the fourth cycle. If the necessity exists to specify the data request REQ in the notice segment 4 of the second message 201, then the second data segment 5 of this message is used for the purpose.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for data transfer in a digital data transfer system with at least two participating devices, the method comprising:
connecting the at least two participating devices through a data connection;
processing, by a processor of the at least two participating devices, a protocol stack;
organizing data exchange between the at least two participating devices via the data connection using a communication call routine in a session layer of the protocol stack;
assigning, by a write-read routine in a transport layer of the protocol stack and configured to at least one of fill or read out a memory buffer, the data to a series of messages; and
defining at least two predefined priority levels in the messages so as to transport the data with different priority levels.

2. The method according to claim 1, wherein each of the messages is subdivided into a plurality of segments, at least one status data segment being defined for data with the highest priority level and at least one data segment being defined for data of other priority levels.

3. The method according to claim 2, wherein a data object is transferred with each data field segment, data of one particular type being aggregated as a data object.

4. The method according to claim 2, wherein the data to be transferred cyclically are entered for transfer into at least one first data field segment and one second data field segment of each of the messages.

5. The method according to claim 2, wherein a notice segment is assigned to at least one of the data field segments, information regarding at least one of whether a request for acyclic data is present and whether the at least one of the data field segments contains requested acyclic data being transferred by means of the notice segment.

6. The method according to claim 3, wherein the data objects are defined in a layer of the protocol stack above the communication call routine.

7. The method according to claim 3, wherein identical protocol stacks are processed by the processor of the at least two participating devices, with the exception of a definition of the data objects which is performed in a configuration step depending on properties of a respective one of the at least two participating devices.

8. A participating device for use in a digital transfer system with at least one other participating device, the participating device comprising:
a communication module configured to connect the participating device with the at least one other participating device through a data connection;
a memory buffer configured to store data;
a processor configured to process a protocol stack;
a communication call routine forming a session layer of the protocol stack configured to provide an organized exchange of data between the participating device and the at least one other participating device through the data connection; and
a write-read routine provided in a transport layer of the protocol stack and configured to at least one of fill or read out the memory buffer, the write-read routine being configured to assign the data to a series of messages each having at least two different predefined priority levels for data of different priority levels.

9. A participating device according to claim 8, wherein each of the messages is subdivided into a plurality of segments, at least one status data segment being provided for data with the highest priority level and at least one data segment being provided for data with other priority levels.

10. The participating device according to claim 9, wherein each of the data segments is present for transferring one data object, data of one particular type being aggregated in the data object.

11. The participating device according to claim 10, wherein a definition of the data object constitutes a layer of the protocol stack above the communication call routine.

12. The participating device according to claim 9, wherein at least one first data field segment and one second data field segment of each of the messages is present for transferring the data to be transferred cyclically.

13. The participating device according to claim 9, wherein a notice segment is assigned to at least one data field segment, the data field segment being present for transferring information regarding at least one of whether a request for acyclic data is present or whether the assigned data field segment contains requested acyclic data.

14. A digital transfer system with at least two participating devices according to claim 8, wherein at least one processor of the at least two participating devices is configured to process identical protocol stacks, with the exception of a configuration which is configured by the system to be carried out depending on the properties of the participating device.

15. The digital transfer system according to claim 14, wherein the configuration includes a definition of data objects of the participating device.
